(19) United States
(12) Patent Application Publication
(10) Pub. No.: US 2018/0252795 A1
(43) Pub. Date: Sep. 6, 2018

(54) ENHANCING INDOOR POSITIONING USING PASSIVE ACOUSTIC TAGS

(71) Applicant: QUALCOMM Incorporated, San Diego, CA (US)

(72) Inventors: Akash KUMAR, Hyderabad (IN); Sai Pradeep VENKATRAMAN, Santa Clara, CA (US); Amit JAIN, San Diego, CA (US)

(21) Appl. No.: 15/449,425

(22) Filed: Mar. 3, 2017

(51) Int. Cl. G01S 5/18; H04W 4/04

(52) U.S. Cl. CPC G01S 5/18; H04W 4/04

(57) ABSTRACT

Techniques for positioning using acoustic tags are provided. An example method for determining a location of a mobile device includes receiving acoustic tag information with the mobile device, the acoustic tag information is associated with an appliance, detecting an acoustic signal with the mobile device, determining a correlation value for the acoustic signal and the acoustic tag information, identifying at least one appliance and a corresponding appliance location based on the correlation value, and determining the location of the mobile device based at least in part on an appliance location.

### BACKGROUND

Devices, both mobile and static, are increasingly equipped to wirelessly communicate with other devices and/or to take measurements from which their locations may be determined and/or locations may be determined based on other devices from which one or more signals are received. A home environment may include multiple wireless devices configured to communicate with one another to exchange operational data. Locations of devices on the network may be determined by the devices themselves, or by another device that is provided with the measurements, or by another device that takes the measurements. For example, a device may determine its own location based on satellite positioning system (SPS) signals, cellular network signals, and/or Wi-Fi signals, etc. that the devices receive. When a device is located indoors, in the absence of a clear view of the sky, SPS positioning methods may be unreliable. Other features associated with an indoor location such as the physical properties of structures and the relative positions of device may also degrade Wi-Fi signal based positioning methods. Similar issues may exist in outside location when satellite, Wi-Fi, and other positioning signals are occluded by manmade or natural structures. The accuracy of a position estimate for a device may be improved if the device can detect and utilize additional signal information associated with a location.

### SUMMARY

An example of a method of determining a location of a mobile device according to the disclosure includes receiving acoustic tag information with the mobile device, such that the acoustic tag information is associated with an appliance, detecting an acoustic signal with the mobile device, determining a correlation value for the acoustic signal and the acoustic tag information, identifying at least one appliance and a corresponding appliance location based on the correlation value, and determining the location of the mobile device based at least in part on an appliance location.

Implementations of such a method may include one or more of the following features. The acoustic tag information may include a sound level and the acoustic signal includes a detected level, and a range between the at least one appliance and the mobile device may be determined based on a comparison of the sound level and the detected level. The acoustic signal may not be in an audible frequency range of human ears. The acoustic tag information may be received from a central controller on a home network. The acoustic tag information may be received from the appliance. The acoustic tag information may include a vector model. The method may include identifying a plurality of appliances and a plurality of corresponding appliance locations based on the correlation value, and determining the location of the mobile device based at least in part on the plurality of corresponding appliance locations.

An example of a mobile device for determining a location according to the disclosure includes a transceiver configured to receive acoustic tag information, such that the acoustic tag information is associated with an appliance, a microphone configured to detect an acoustic signal, a processor operably coupled to the transceiver and the microphone, and configured to determine a correlation value for the acoustic signal and the acoustic tag information, identify at least one appliance and a corresponding appliance location based on the correlation value, and determine the location of the mobile device based at least in part on an appliance location.

Implementation of such a mobile device may include one or more of the following features. The acoustic tag information may include a sound level and the acoustic signal includes a detected level, and the processor may be further configured to determine the location of the mobile device based at least in part on a comparison of the sound level and the detected level. The microphone may be configured to detect the acoustic signal that is not in an audible frequency range of human ears. The acoustic tag information may be received from a central controller on a wireless home network. The acoustic tag information may be received from the appliance on a wireless home network. The acoustic tag information may include a vector model. The processor may be further configured to activate the microphone to detect one or more acoustic signals when an emergency 911 call is placed.

An example of an apparatus for determining a location of a mobile device according to the disclosure includes means for receiving acoustic tag information with the mobile device, such that the acoustic tag information is associated with an appliance, means for detecting an acoustic signal with the mobile device, means for determining a correlation value for the acoustic signal and the acoustic tag information, means for identifying at least one appliance and a corresponding appliance location based on the correlation value, and means for determining the location of the mobile device based at least in part on an appliance location.

An example of a non-transitory processor-readable storage medium according to the disclosure comprises processor-readable instructions configured to cause one or more processors to determine a location of a mobile device including code for receiving acoustic tag information with the mobile device, such that the acoustic tag information is associated with an appliance, code for detecting an acoustic signal with the mobile device, code for determining a correlation value for the acoustic signal and the acoustic tag information, code for identifying at least one appliance and a corresponding appliance location based on the correlation value, and code for determining the location of the mobile device based at least in part on an appliance location.

Items and/or techniques described herein may provide one or more of the following capabilities, as well as other capabilities not mentioned. A wireless home network may include multiple appliances and/or devices and a central controller. An appliance may communicate and exchange data with the central controller and other devices on the network. The appliances may be configured to communicate with one another directly. The appliances may be identified based on the sounds produced during operation (e.g., an acoustic output). The acoustic output may be outside the audible frequency range of the human ear. The acoustic output may be used to generate one or more acoustic tags which are associated with an appliance and the location of the appliance. The acoustic tag information for the appliances in the home environment may be stored on the central controller and provided to other devices on the network. A mobile device may utilize a microphone to capture the acoustic outputs of one more devices on the network. The captured acoustic output may be compared to the previously stored acoustic tags to determine a match. The locations of one or more matching appliances may be used to determine the location of the mobile device. The amplitude of the captured acoustic output may be used to refine the location estimate. Other capabilities may be provided and not every implementation according to the disclosure must provide any, let alone all, of the capabilities discussed.

### BRIEF DESCRIPTION OF THE DRAWINGS

FIG. 1 is a simplified view of a communication system.

FIG. 2 is a simplified top view of an indoor portion of an example communication system.

FIG. 3 is a block diagram of components of communication device shown in FIG. 2.

FIG. 4 is an example use case of a mobile device receiving multiple acoustic signals.

FIG. 5 is an example use case of using acoustic tags in a household communication system.

FIG. 6 is a block flow diagram of a process for generating an acoustic tag from an acoustic signal.

FIG. 7 is a block diagram of components of a central controller shown in FIGS. 2 and 5.

FIG. 8 is an example message flow for determining a position based on an acoustic tag.

FIGS. 9A-9C are example data tables for use in acoustic tag based positioning.

FIG. 10A is a block flow diagram of a method of sending acoustic tag information to a mobile device.

FIG. 10B is a block flow diagram of method for determining the position of a mobile device.

FIG. 11 is a block flow diagram of a method of sending acoustic tag information to a central controller.

### DETAILED DESCRIPTION

Techniques are discussed herein for utilizing acoustic tag information to determine the location of a mobile device in a household communication system. An increasing number of household smart devices are becoming available to the consumer market. These smart devices are capable of communicating with a wireless home network and/or other devices to store and exchange data. Acoustic tag information is an example of the type of data that may be stored and exchanged over the home network or the various devices. For example, various appliances and devices in a home environment have distinct sounds at power up, during operation, and at other points in their operational cycle. In an example, the appliances and devices may be configured to emit a specific sound or series of sounds upon receipt of a command. The sounds may be outside the audible range of the human ear. The acoustic tag information may be specific signature sounds tags from the various appliances and devices. Since most home appliances are stationary, their corresponding positions may be used as reference sources to determine the position of a mobile device. The acoustic tag information may also be used in conjunction with current positioning techniques to improve the location accuracy.

Acoustic tags may be created for the appliances/devices in a home environment. The acoustic tags will contain specific unique sound patterns of the sound corresponding to the device. Whenever a mobile device (e.g., a smartphone, tablet, laptop, etc.) needs to determine its location, it will activate or use a microphone to sense the sound input from its surroundings. The mobile device will then perform a cross correlation of the sound samples sensed from the microphone with each of the available stored acoustic tags. Based on the cross-correlation results, the device will be able to determine the sounds being picked up by the microphone and their relative strength. Since the positions and/or coordinates of the sound generating stationary devices and acoustic levels are known, range based trilateration can be used to determine the location of the mobile device. Proximity based location or relative positioning may also be used.

In an example, a mobile device may include a data structure including one or more data tables (e.g., look up tables) containing the acoustic tags of the corresponding appliances/devices in a home environment and the corresponding locations (e.g., position/coordinate information). This may be implemented as a software application, and the acoustic tag information may be loaded to the mobile device when it registers to a home WiFi access point (e.g., a central controller). The acoustic tag information may be provided from an appliance to a mobile device directly when a mobile device is within communications range. The acoustic tags may be based on the default sounds of an appliance once a location request is executed, or the acoustic tags may be based on a sound at a specific level, direction, frequency etc. that the appliance may be directed to transmit when the location request is executed. An appliance/device may provide factory set acoustic tag information as part of registration process with the home network (e.g., registering an ID, which may encapsulate information such as type, brand, model etc.), or when communications are exchanged with another device directly (e.g., without using a central controller). A unique appliance ID may be used by a central controller to download acoustic tag information from a remote server and add the information to a local acoustic map. This acoustic map can then be available to all of the devices in the home environment. A device may include selectable options for the acoustic tags, and a user or the central controller may be configured to select one or more of the options. For example, a device may have selectable default sounds associated with different operations and the user may select the desired default sounds.

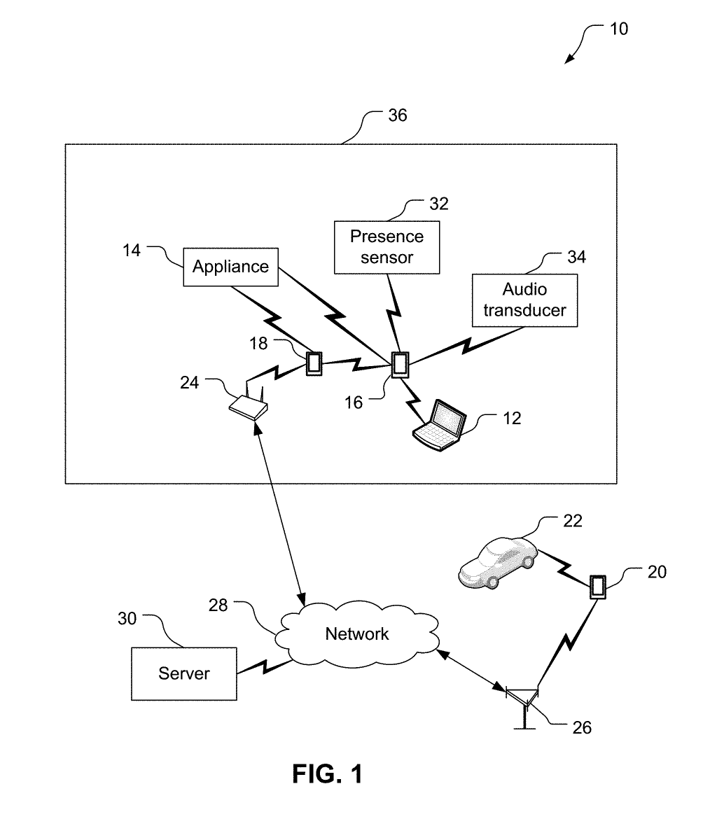

Referring to FIG. 1, a communication system 10 includes devices 12, 14, 16, 18, 20, 22, an access point 24, a base station 26, a network 28, a server 30, a presence sensor 32, and an audio transducer 34. The devices 12, 14, 16, 18, the access point 24, the presence sensor 32, and the audio transducer 34 are disposed inside a structure 36 (e.g., a building). The system 10 is a communication system in that components of the system 10 can communicate with one another directly or indirectly, e.g., via the network 28 and/or the access point 24 and/or the base station 26 (or other access points and/or other bases stations not shown). The system 10 is a communication system in that at least some of the components of the system 10 can communicate with one another wirelessly. For example, the base station 26 and the device 20 may communicate wirelessly using signals according to one or more protocols such as LTE, GSM, CDMA, or OFDM. The single access point 24 and the single base station 26 are examples only, and other quantities of access points and/or base stations may be used. Also, the types of the devices 12, 14, 16, 18, 20, 22 (e.g., an appliance, a smart phone, a tablet computer, a laptop computer, and a car) are examples and other types of devices may be used, whether currently existing or developed in the future. The term “base station” does not limit the base station 26 to any particular form, protocol, etc. For example, any of the base station 26 (and/or other base stations not shown) may be referred to as a base transceiver station (BTS), an access node (AN), a Node B, an evolved Node B (eNB), etc. Further, the device 22 is a car and while the primary function of a car is not as a communication device, the car will comprise a communication device as a part of the car, and for simplicity of the disclosure the car is considered as one type of communication device herein.

The system 10 comprises an Internet of Things (IoT) network in this example, with the devices 12, 14, 16, 18, 20, 22 configured to communicate with each other, particularly through one or more short-range wireless communication techniques. The system 10 being an IoT network is, however, an example and not required. Examples of short-range wireless communication techniques include BLUETOOTH communications, BLUETOOTH Low-Energy communications, and Wi-Fi communications. The devices 12, 14, 16, 18, 20, 22 may broadcast information, and/or may relay information from one of the devices 12, 14, 16, 18, 20, 22 to another or to another device such as the access point 24 and/or the base station 26. One or more of the devices 12, 14, 16, 18, 20, 22 may include multiple types of radios, e.g., a BLUETOOTH radio, a WLAN/Wi-Fi radio, a cellular radio (e.g., LTE, CDMA, 3G, 4G, etc.), etc. such that information may be received using one radio and transmitted using a different radio. Further, one or more of the devices 12, 14, 16, 18, 20, 22 may be configured to determine range to another of the devices 12, 14, 16, 18, 20, 22 (e.g., using round-trip time (RTT), or observed time difference of arrival (OTDOA), or received signal strength indications (RSSI), or one or more other techniques, or a combination of one or more of any of these techniques) and/or to determine angle of arrival (AOA) of a signal from another of the devices 12, 14, 16, 18, 20, 22 and/or from one or more other devices such as the access point 24 and/or the base station 26.

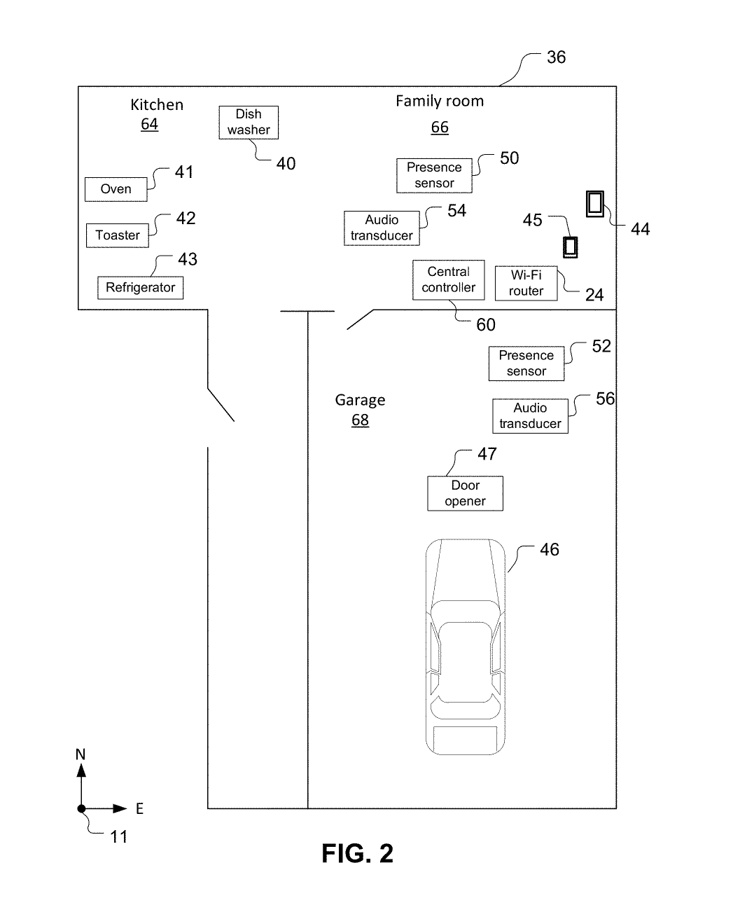

Referring to FIG. 2, and indoor portion of the system 10 inside of the structure 36 includes wireless communication appliances/devices 40, 41, 42, 43, 44, 45, 47, presence sensors 50, 52, audio transducers 54, 56, a central controller 60, and the access point 24 (here a WLAN/Wi-Fi router). In this example, the devices 40-47 include a dishwasher 40, an oven 41, a toaster 42, and a refrigerator 43 disposed in a kitchen 64, a tablet 44, a smart phone 45, and a television disposed in a family room 66, and a car 46 and a garage door opener 47 disposed in a garage 68. These devices 40-47 are configured to communicate with each other if within communication range of each other, and to communicate with the presence sensors 50, 52 and the central controller 60. Using the communication capabilities between each other, information regarding the devices 40-47 may be sent to each other, relayed to other devices, or even relayed to the central controller 60. Further, communications from the central controller 60 may be received by, or forwarded by, the devices 40-47. Further still, the central controller 60 may be a standalone device as shown in FIG. 2 or may be incorporated into any of the devices 40-47. The system 10, in this example, provides an IoT network that can generate, send, receive, relay or forward, various information (e.g., attributes, attribute tables, information relating to attributes, signal measurements, location indications, acoustic tag information, etc.) to facilitate functionality described herein. The devices 40-47 are examples only, and other types of devices, as well as other quantities of devices, may be used.

The presence sensors 50, 52 facilitate detection of the presence of devices and/or users. The presence sensors 50, 52 may detect the presence of devices and/or persons in any of a variety of ways. For example, either or both of the presence sensors 50, 52 may comprise a movement sensor, e.g., that sends signals, measures their reflections, and compares present reflections with previous reflections. The signals may be visible or non-visible (e.g., infrared) light signals and audible or non-audible (e.g., ultrasound) sound signals. Either or both of the presence sensors 50, 52 may comprise a heat sensor, e.g., including an infrared sensor. Either or both of the presence sensors 50, 52 may be communicatively coupled (e.g., hard-wired or wirelessly in communication with) one or more of the devices 40-47 and/or the central controller 60. The presence sensors 50, 52 are configured to report the detection of presence (possibly only if new, or possibly new and ongoing) of a relevant object such as a person.

The audio transducers 54, 56 facilitate the reception and provision of commands from users to the central controller 60 or other appropriate device. The audio transducers are preferably communicatively coupled (e.g., hard-wired or in wireless communication with) the central controller 60 and are configured to receive verbal commands, convert these commands to electrical signals, and send the signals to the central controller 60 or other appropriate device. The audio transducers 54, 56 may send the signals to the central controller 60 or other appropriate device directly or indirectly (e.g., through one or more intermediate devices that relay the signals) such as one or more of the devices 40-47.

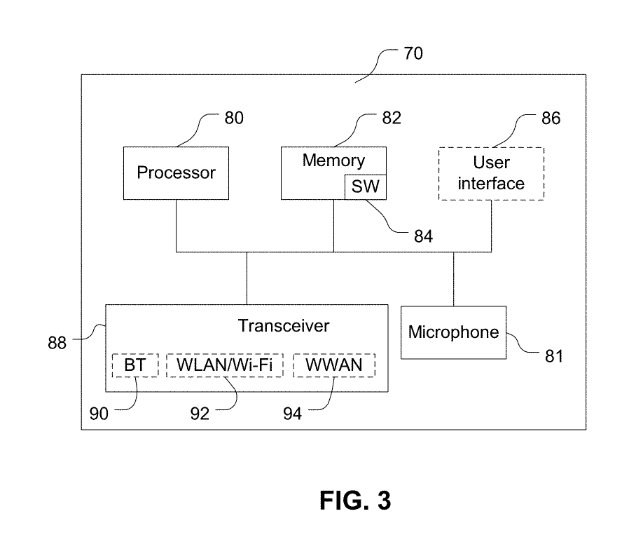

Referring to FIG. 3, with further reference to FIG. 1, an example device 70 comprises a computer system including a processor 80, a microphone 81, a memory 82 including software (SW) 84, an optional user interface 86, and a transceiver 88. The processor 80 is preferably an intelligent hardware device, for example a central processing unit (CPU) such as those made or designed by QUALCOMM®, ARM®, Intel® Corporation, or AMD®, a microcontroller, an application specific integrated circuit (ASIC), etc. The processor 80 may comprise multiple separate physical entities that can be distributed in the device 70. The microphone 81 may include a transducer and other circuitry for providing acoustic information to the processor 80 in a digital or analog format. The microphone 81 may be a high sensitivity or high bandwidth microphone configured to detect acoustics that are not in the audible frequency range of human ears. The memory 82 may include random access memory (RAM) and/or read-only memory (ROM). The memory 82 is a non-transitory, processor-readable storage medium that stores the software 84 which is processor-readable, processor-executable software code containing instructions that are configured to, when performed, cause the processor 80 to perform various functions described herein. The description may refer only to the processor 80 or the device 70 performing the functions, but this includes other implementations such as where the processor 80 executes software and/or firmware. The software 84 may not be directly executable by the processor 80 and instead may be configured to, for example when compiled and executed, cause the processor 80 to perform the functions. Whether needing compiling or not, the software 84 contains the instructions to cause the processor 80 to perform the functions. The processor 80 is communicatively coupled to the memory 82. The processor 80 in combination with the memory 82, the user interface 86 (as appropriate), and/or the transceiver 88 provide means for performing functions as described herein, for example, means for determining a location of a networked appliance, and a means for sending location and acoustic tag information to a central controller. In example, the device 70 may be the means for receiving acoustic tag information, means for detecting an acoustic signal, means for determining a correlation value for an acoustic signal and an acoustic tag information, means for identifying at least one appliance and a corresponding appliance location based on the correlation value, means for determining a location of the mobile device based at least in part on the appliance location, means for determining a range between at least one appliance and the mobile device based on a comparison of a sound level and a detected level, and means to activate a microphone to detect one or more acoustic signals when an emergency 911 call is placed. The software 84 can be loaded onto the memory 82 by being downloaded via a network connection, uploaded from a disk, etc. The device 70 may be any of the devices 40-47 shown in FIG. 2, or another device. The user interface 86 (e.g., a display and/or speaker) is optional, e.g., with the tablet 44 and the smart phone 45 including a display, a microphone 81, and a speaker while the garage door opener 47 does not (typically) include a display, a microphone 81, or a speaker, although the garage door opener 47 may include a user interface of some sort, e.g., switches operable by a user.

The transceiver 88 is configured to send communications wirelessly from the device 70 and to receive wireless communications into the device 70, e.g., from the devices 40-47, the access point 24, or the central controller 60. Thus, the transceiver 88 includes one or more wireless communication radios. In the example shown in FIG. 3, the transceiver 88 optionally includes a BLUETOOTH radio 90, a Wireless Local Area Network (WLAN)/Wi-Fi radio 92, and a Wireless Wide Area Network (WWAN) radio 94. A WWAN may include techniques used for a Wideband Code Division Multiple Access (WCDMA) network implementing Universal Terrestrial Radio Access (UTRA) defined by 3GPP, a Long Term Evolution (LTE) network implementing Evolved Universal Terrestrial Radio Access (E-UTRA) defined by 3GPP, etc. WCDMA is part of Universal Mobile Telecommunication System (UMTS). LTE is part of 3GPP Evolved Packet System (EPS). WCDMA, LTE, UTRA, E-UTRA, UMTS and EPS are described in documents from 3GPP. The WWAN may include techniques such as Global Stems for Mobile Communication (GSM), Code Division Multiple Access (e.g., CDMA2000), and cellular digital packet data (CDPD). The techniques may also be used for other wireless networks (e.g., 3GPP and 3GPP2 networks) and other radio technologies. As shown, each of the radios 90, 92, 94 are optional, although the transceiver 88 will include at least one wireless communication radio. Further, one or more other types of radios may be included in the device 70 in addition to, or instead of, the radio(s) 90, 92, 94. If the transceiver 88 includes more than one wireless communication radio, then the transceiver 88 may receive a wireless communication using one of the wireless communication radios, and transmit (e.g., relay or forward), the communication (or a portion thereof) using a different wireless communication radio. The communication may be transmitted to another of the devices 40-47 or to another device such as the access point 24. Thus, for example, the device 70 may receive a wireless communication using the BLUETOOTH radio 90, and forward the communication using the WLAN/Wi-Fi radio 92 to another device that does not include a BLUETOOTH radio.

The processor 80 is configured to relay communications between devices, for example, from the central controller 60 the devices 40-47 or from the devices 40-47 to the central controller. For example, the processor 80 may receive, via the transceiver 88, the request from the central controller 60 (directly or indirectly, e.g., from another of the devices 40-47) for the location of one of the devices 40-47. The processor 80 may relay the request to one or more of the devices 40-47 within communication range of the device 70. The processor 80 is further configured to relay a reply from any of the devices 40-47 to the central controller 60, or to another device for further relay until the reply reaches the central controller 60. The reply, for example, may be a location of a target device, and the location may be a distance relative to another device, for example from the device from which the reply is received.

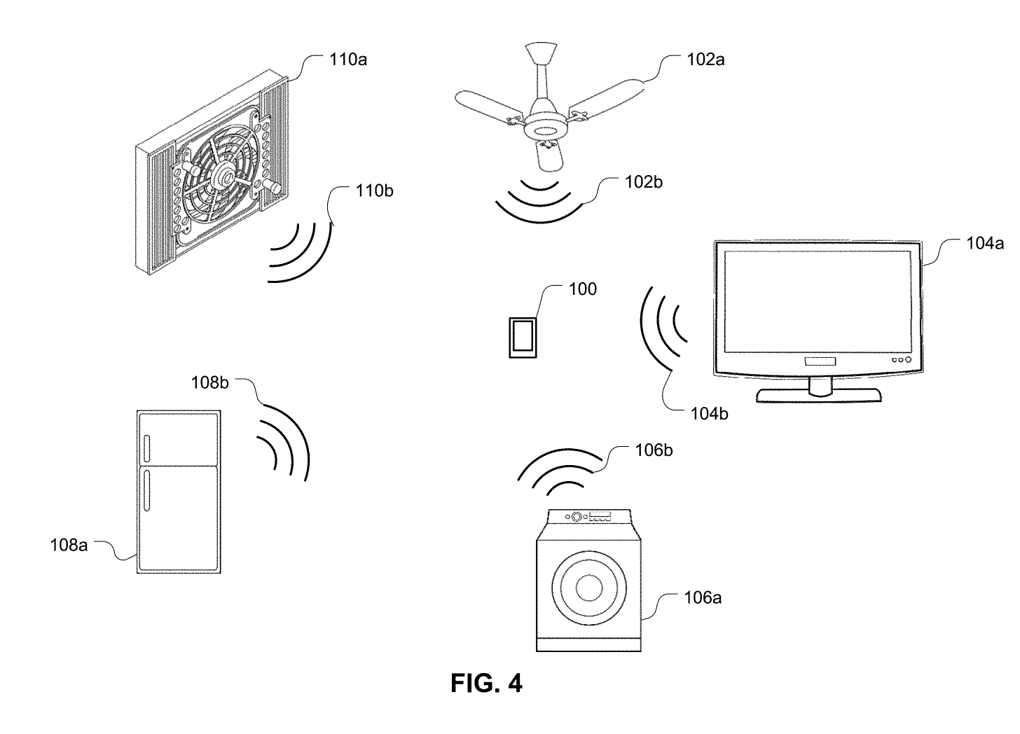

Referring to FIG. 4, with further reference to FIG. 2, an example use case of a mobile device 100 receiving multiple acoustic signals from household devices is shown. The mobile device 100 may be a smartphone, tablet, laptop computer, wristwatch device, or similar mobile devices including an acoustic sensor such as a microphone. The microphone may be a high sensitivity or high bandwidth microphone capable of detecting acoustic signals outside of the audible frequency range of human ears. The household devices depicted in FIG. 4 are exemplary only and not a limitation as other devices in the Internet of Things (IoT) may be used. The household devices may include a ceiling fan 102a, a television 104a, a washing machine 106a, a refrigerator 108a, and an air conditioning unit 110a. Each of the devices 102a, 104a, 106a, 108a, 110a may be configured to wirelessly communicate with one another directly or via a home network, such as through the central controller 60. During a network registration process (e.g., when the devices join the home network), the devices may send acoustic tag information to the central controller 60. The acoustic tag information contains data associated with the sounds emitted by the device such as during operation. For example, the acoustic tag information may be vector space models associated with sounds emitted by the devices which may be stored on the central controller 60 or the mobile device 100. The ceiling fan 102a may emit a distinctive fan sound 102b including a beat pattern corresponding to the speed of the fan. The television 104a may emit a TV sound 104b, such as sounds in the range of 50-15,000 Hz during normal operation. In an example, the television 104a may emit an in-band signal, such as a sub-audible tone (e.g., 25, 35, 50, 70 Hz), when a position of mobile device is desired (e.g., on command). The washing machine 106a may generate one or more washing machine sounds 106b at different points during the washing cycle (e.g., wash, spin, cycle complete alarms). The refrigerator 108a may generate refrigerator sounds 108b when a compressor within the unit is running. The refrigerator sounds 108b may also be audible tones emitted from a speaker on the refrigerator 108a when the mobile device 100 requests positioning assistance. The air conditioning unit 110a may generate an air conditioning sound 110b based on an internal motor and fan assembly. The devices 102a, 104a, 106a, 108a, 110a and corresponding noises are examples only. Each of the devices 102a, 104a, 106a, 108a, 110a may produce acoustic outputs that are in not in the audible frequency range of human ears but may be detected by high sensitivity/bandwidth microphones. In an example, some devices such as the television 104a, the washing machine 106a and the refrigerator 108a may include speakers and the corresponding emitted sounds 104b, 106b, 108b may be provided based on a command received from the mobile device 100 or other networked controller. The sounds generated by may be due to other factors and components with the respective devices.

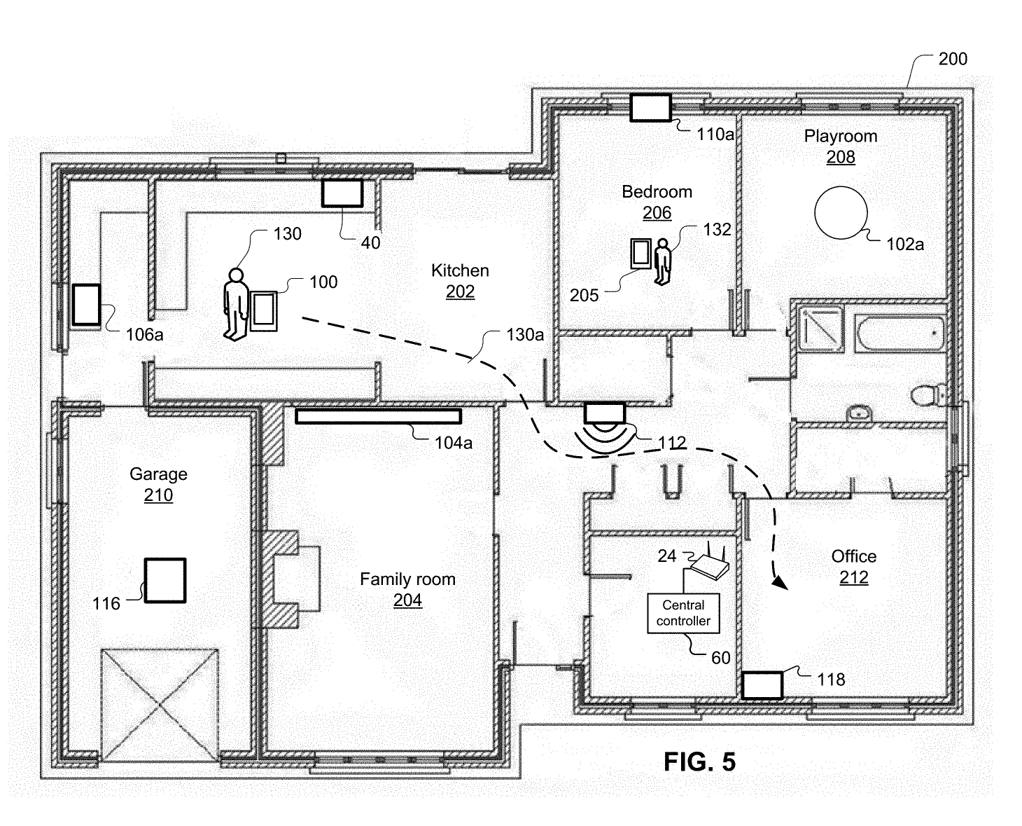

Referring to FIG. 5, with further reference to FIGS. 2 and 4, an example use case of device positioning based on acoustic tags in a household communication system is shown. The household communication system is shown in the context of a home 200. The home 200, the devices, and users therein are exemplary only, and not a limitation. The home 200 includes a kitchen 202, a family room 204, a bedroom 206, a playroom 208, a garage 210, and an office 212. The household communication system includes a home network with an access point 24 and a central controller 60 which may be the same device (e.g., the central controller 60 may include the access point 24). Example devices within the home 200 include a dishwasher 40, a ceiling fan 102a, a television 104a, a washing machine 106a, a doorbell 112, a garage door opener 116, and a dehumidifier 118. The home 200 also includes a first user 130 with a mobile device 100, and a second user 132 with a tablet 205. Each of the devices 40, 100, 102a, 104a, 106a, 110a, 112, 116, 118 may include elements of the device 70 in FIG. 3 and are configured to communicate with the central controller 60 (e.g., via the access point 24) or with one another.

The following operational use cases are provided as examples to facilitate the explanation of enhancing a position with acoustic tags. The mobile device 100 and the tablet 205 are communicating with the central controller 60 via the access point 24. The central controller 60 is configured to provide acoustic tag information to the mobile device 100 and the tablet 205 during a device registration process (e.g., when the devices join the home network). In one example, the user 130 may carry the mobile device 100 into the kitchen 202. The kitchen 202 includes a dishwasher 40 that is currently in operation. The microphone on the mobile device 100 may detect a sound radiating from the dishwasher 40 and the processing system within the mobile device is configured to perform an acoustical analysis on the sound captured by the microphone. In an example, the mobile device 100 may also detect sounds generated by the washing machine 106a and the processing system may estimate a position based on both the dishwasher 40 and the washing machine 106a. The user 130 may carry the mobile device 100 along a path 130a from the kitchen 202 to the office 212. The microphone on the mobile device 100 may detect the diminishing signal amplitude (e.g., signal strength, volume) of the washing machine 106a and the dishwasher 40 as the user moves out of the kitchen 202. The change in signal amplitude may be used as a trigger to activate a positioning algorithm on the home network. For example, the doorbell 112 may be configured to emit a tone (e.g., sub-audible, audible, or super-audible) after movement is detected. The signal amplitude of the doorbell tone received at the mobile device 100 may be used to determine an approximate distance to the doorbell 112. The microphone on the mobile device 100 may utilize different sampling rates based on current state of the mobile device. The state of the mobile device may be based on inertial navigation sensors (e.g., accelerometers, gyroscopes) such that the acoustic sampling rate will increase when movement is detected. The microphone may periodically sample for acoustic signals until the amplitude values of one or more acoustic signals stabilize. For example, when the mobile device 100 enters the office 212 the acoustic sound generated by the dehumidifier 118 is detected at a stable level (e.g., consecutive samples have amplitudes within 5%-10% of one another), then the acoustic sampling rate may decrease.

The central controller 60 may be configured to maintain a log (e.g., data table) of the current location of a user and execute a positioning algorithm if the location information becomes stale (e.g., exceeds a time threshold). The positioning algorithm may include remotely activing the microphone and processing system on a mobile device to determine local acoustic signals. For example, the second user 132 and the tablet 205 may be located in the bedroom 206 (e.g., while taking a nap). The central controller 60 may signal the tablet 205 to obtain an acoustic sample (e.g., including the air conditioning unit 110a). The tablet may be configured to determine its location based on the acoustic analysis of the sound emitted from the air conditioning unit 110a (i.e., local processing), or the tablet may be configured to provide a file containing the acoustic sample to the central controller (e.g., remote processing). In either case, the central controller 60 is configured to update the location of the tablet 205. In an embodiment, the positioning algorithm on the central controller 60 may also include remotely simultaneously activating an acoustic signal on one or more devices in the household communication network as well as remotely activating the microphone on the mobile device.

The tablet 205 may be configured to communicate with air conditioning unit 110a directly without connecting to the home network and the central controller. When the second user 132 and the tablet 205 enter the bedroom 206, the tablet 205 and air conditioning unit 110a may exchange information. The air conditioning unit 110a may include one or more data tables including the acoustic tag information for the devices in the home environment, and the tablet 205 is configured to receive the acoustic tag information from the air conditioning unit 110a. Alternatively, the tablet 205 may include data tables including the acoustic tag information for other devices in the home 200 and may be configured to provide the acoustic tag information to the air conditioning unit 110a directly. The acoustic tag information for the devices within the home 200 may propagate throughout the home based on direct communications with one another and without using a centrally controlled architecture.

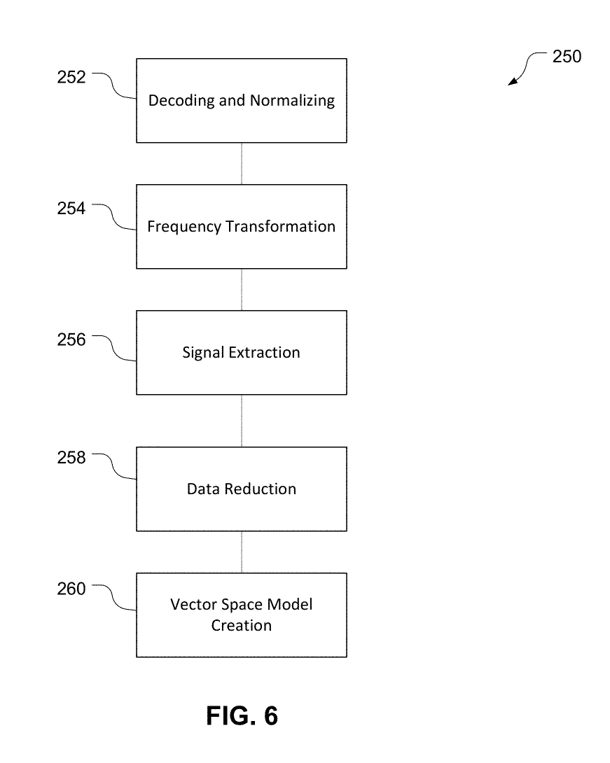

Referring to FIG. 6, with further reference to FIGS. 3-5, a block flow diagram of a process 250 for generating an acoustic tag from an acoustic signal is shown. The process 250 is, however, an example only and not limiting. The process 250 can be altered, e.g., by having stages added, removed, rearranged, combined, performed concurrently, and/or having single stages split into multiple stages. The process 250 may be executed on the mobile device 100 or on other computer systems, such as the central controller 60.

At stage 252, the process includes decoding and normalizing a captured acoustic signal (e.g., a sound). The microphone 81 and the processor 80 in the mobile device 100 are configured to decode and normalize a captured acoustic sound. In an example, the microphone 81 and the processor 80 are configured to digitize a time continuous acoustically captured sound. Based on the duration and the dynamic range of the captured sound, a time frame and sampling rate may be selected. For example, the acoustic sound may include a low frequency beat (e.g., <1 Hz) such as generated by the dishwasher 40 and a sampling rate of 10 Hz for 3-5 seconds may be used to capture the acoustic sound. Other devices, such as the ceiling fan 102a, may have higher beat frequencies and higher sampling rates may be used to capture the corresponding acoustic sound. For high frequency sounds (e.g., above the audible range of the human ear), a shorter sampling time frame and sampling rate may be used.

At stage 254, the process includes executing a frequency transformation. The processor 80 may be configured, for example, to perform a Fast Fourier Transform (FFT) or wavelet transform on the captured time domain signal to extract the frequency components. Other frequency analysis and feature extraction algorithms may also be used to identify the frequency components in an acoustic sound.

At stage 256, the process includes performing a signal extraction. The processor 80 may be configured to implement digital processing noise removing filters to reduce the background noise level and correct the noise floor of the captured acoustic signal. For example, the signal extraction may implements methods such as Fourier coefficients, mel-frequency cepstral coefficients (MFCCs), spectral flatness, sharpness, peak-trajectories, and principal components analysis (PCA). Other signal extraction techniques may also be used.

At stage 258, the process includes performing a data reduction process. The processor 80 may be configured to execute algebraic techniques such as singular value decomposition (SVD), lower upper (LU) decomposition, or QR decomposition. Other techniques may also be used to reduce the large matrices generated by the stage above for ease of computation with a minimal loss of information. The result of the data reduction process generates a vector model which is an acoustic tag.

At stage 260, the process includes creating a vector space model. The processor 80 may be configured to create a vector space model based on acoustic tags. A collection of such vector space models (e.g., the acoustic tag information) may be stored in a database such as in the central controller 60. Retrieval algorithms may be used to match the vector model of a newly generated acoustic tag (e.g., based on a captured acoustic signal) against the database of previously stored acoustic tags. Correlation algorithms or other match filtering techniques may be used to identify a previously stored acoustic tag with an acoustic tag generated from a currently captured acoustic signal.

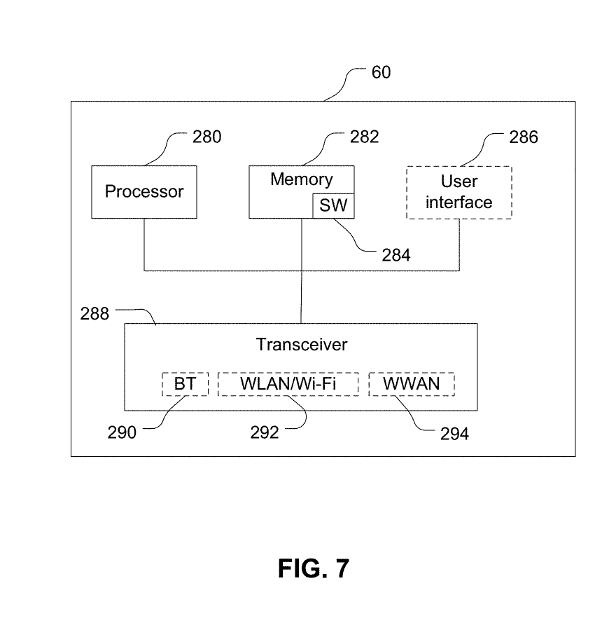

Referring to FIG. 7, with further reference to FIGS. 2 and 5, an example of the central controller 60 comprises a computer system including a processor 280, a memory 282 including software (SW) 284, an optional user interface 286, and a transceiver 288 optionally including a BLUETOOTH (BT) radio 290, a WLAN/Wi-Fi radio 292, and/or an WWAN radio 294. Other types of radios may also or alternatively be used, e.g., a BLUETOOTH-Low Energy (BT-LE) radio. The processor 280 is preferably an intelligent hardware device, for example a central processing unit (CPU) such as those made or designed by QUALCOMM®, ARM®, Intel® Corporation, or AMD®, a microcontroller, an application specific integrated circuit (ASIC), etc. The processor 280 may comprise multiple separate physical entities that can be distributed in the central controller 60. The memory 282 may include random access memory (RAM) and/or read-only memory (ROM). The memory 282 is a non-transitory, processor-readable storage medium that stores the software 284 which is processor-readable, processor-executable software code containing instructions that are configured to, when performed, cause the processor 280 to perform various functions described herein. The description may refer only to the processor 280 or the central controller 60 performing the functions, but this includes other implementations such as where the processor 280 executes software and/or firmware. The software 284 may not be directly executable by the processor 280 and instead may be configured to, for example when compiled and executed, cause the processor 280 to perform the functions. Whether needing compiling or not, the software 284 contains the instructions to cause the processor 280 to perform the functions. The processor 280 is communicatively coupled to the memory 282. The processor 280 in combination with the memory 282, the user interface 286 (as appropriate), and/or the transceiver 288 provide means for performing functions as described herein, for example, means for receiving registration information from a networked appliance, means for determining acoustic tag information for the networked appliance, and means for sending the acoustic tag information to a mobile device. The software 284 can be loaded onto the memory 282 by being downloaded via a network connection, uploaded from a disk, etc. The central controller 60 is shown in FIGS. 2 and 5 as a standalone device separate from the devices 40-47, 100, 102a, 104a, 106a, 110a, 112, 116, 118, 205 but the central controller 60 could be implemented by one or more of the devices 40-47, 100, 102a, 104a, 106a, 110a, 112, 116, 118, 205 and/or one or more other wireless communication devices such as the WLAN/Wi-Fi router 24. The central controller 60 is preferably, though not necessarily, a (primarily) static device.

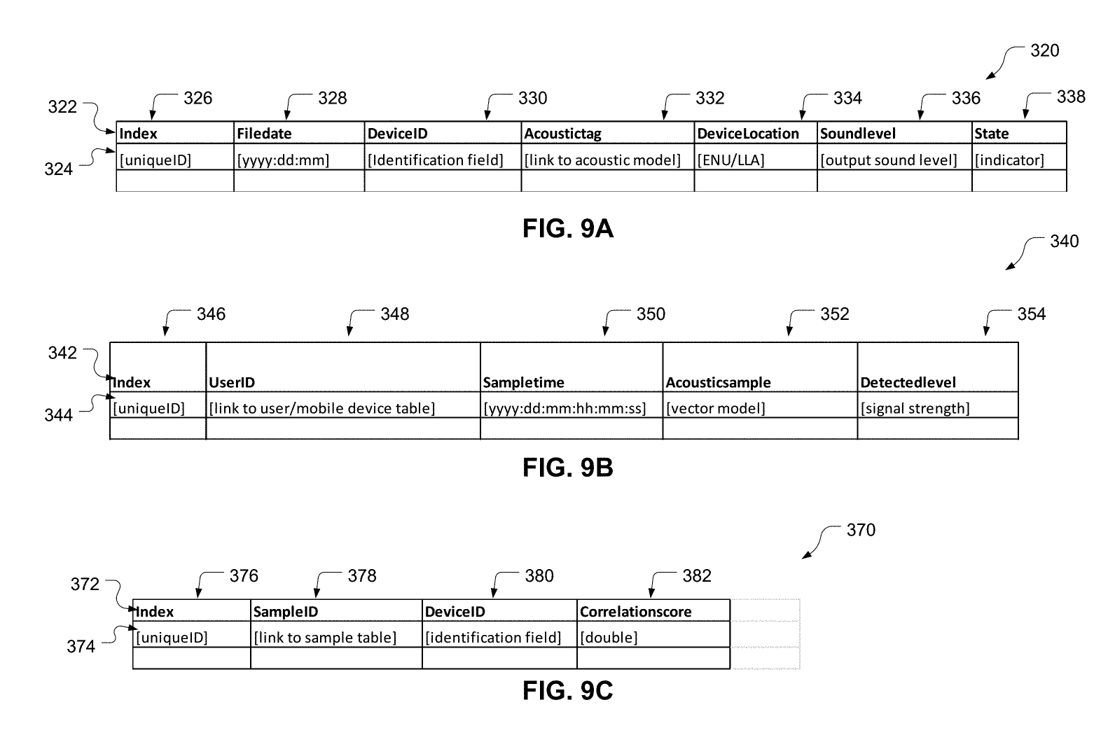

The processor 280 is configured to generate, store (via the memory 282), modify, and transmit (via the transceiver 288) acoustic tag information corresponding to the devices 40-47, 102a, 104a, 106a, 110a, 112, 116, 118. The acoustic tag information may be stored by other devices and their respective values will typically vary depending on that device. In an example, referring also to FIGS. 9A, 9B and 9C, the processor 280 may generate and maintain acoustic tag attribute tables 320, 340, 370 including indications of attributes 322, 342, 372 and respective values 324, 344, 374. The first acoustic tag attribute table 320 includes an index 326, a file date 328, a device ID 330, acoustic tag information 332, device location 334, sound level 336, and a state indicator 338. The index 326 may uniquely identify a record in the table 320. The file date 328 may indicate the date and corresponding version information for acoustic tag associated with an appliance/device. For example, the file date 328 may be used to ensure the most current acoustic tag information is being used. The device ID 330 may include identification information to uniquely identify an appliance/device in a home environment. In an example, the device ID 330 may include elements to identify the device manufacturer, the device model number, and a device serial number. The acoustic tag 332 may include one or more vector models based on the acoustic output of the device. The acoustic tag 332 may include an index value (e.g., pointer value) linked to a related acoustic tag table if a single device can be associated with many vector models (e.g., if the device has different modes of operations which generate different sounds). The device location 334 identifies the current location of the associated device (i.e., the device associated with the device ID 330) in an appropriate position notation/coordinate system. The current location may be based on a relative position including a room name (e.g., kitchen, family room, bedroom, etc.). The location may be based on a value in ENU (East, North, up) coordinates based on common reference point (e.g., origin). In an example, the locations may be provided in a Latitude, Longitude and Altitude (LLA) format. Other position notations and/or coordinate systems may be used to characterize the current location of a device. The sound level 336 may include information to indicate a baseline signal strength (e.g., in decibels) of the sound modeled by the acoustic tag 332. In an example, the sound level 336 may be included in a linked table with the acoustic tag information. The state indicator 338 may include an indication of the current state of the associated device. For example, if the state of the device is ‘off’ then the acoustic tag information will not be included during a matching operation. Other attribute fields may be associated with a device may also be included in the table 320.

The second acoustic tag attribute table 340 includes attributes associated with detecting an acoustic sample with a mobile device 100. For example, the table 340 includes an index 346, a user ID 348, a sample time 350, an acoustic sample 352, and a detected level 354. The index 346 may uniquely identify a record in the table 340. The user ID 348 may uniquely identify a particular mobile device 100, or a user 132. For example, the user of a device may be determined via log in credentials. In an example, the user ID includes a link (e.g., pointer) to one or more related device and/or user tables. The sample time 350 indicates the time at which the acoustic sample 352 was obtained. In an example the sample time 350 may include start and end time values. The acoustic sample 352 includes a vector model based on the acoustic sample. For example, the acoustic sample 352 may be generated via the process 250 in FIG. 6. In an example, the acoustic sample 352 may also include an audio recording (e.g., .wav, .mp3, etc.) of the acoustic sample obtained by the mobile device. The acoustic sample 352 will be used in a correlation or matching process with the acoustic tag 332. The detected level 354 includes a signal strength value (e.g., decibels) for the captured acoustic sample. In an example, the detected level 354 may be compared to the sound level 336 to determine a rough distance between the mobile device 100 and the appliance associated with the acoustically matching appliance.

The third acoustic tag attribute table 370 includes attributes associated with matching an acoustic sample 352 with an acoustic tag 332. For example, the table 370 includes an index 376, a sample ID 378, a device ID 380, and a correlation score 382. The index 376 uniquely identifies a record in the table 370. The sample ID 378 includes a linking value to the second acoustic tag attribute table 340. For example, the sample ID 378 may include an index value such as the index 346. The device ID 380 includes the identification information of a matching appliance/device. For example, the sample ID 378 provides the relation to the acoustic sample 352. The acoustic sample 352 may be used in a correlation or matching algorithm to identify an appliance/device based on a matching acoustic tag 332. Thus, the device ID 380 is the device ID 330 based on an indication of a possible match between the acoustic sample 352 (i.e., as associated via the sample ID 378) and the acoustic tag 332. The correlation score 382 includes an indication of the strength of the correlation between the acoustic sample 352 and the acoustic tag 332. In an example, a threshold correlation value may be established to define a sufficient matching criterion.

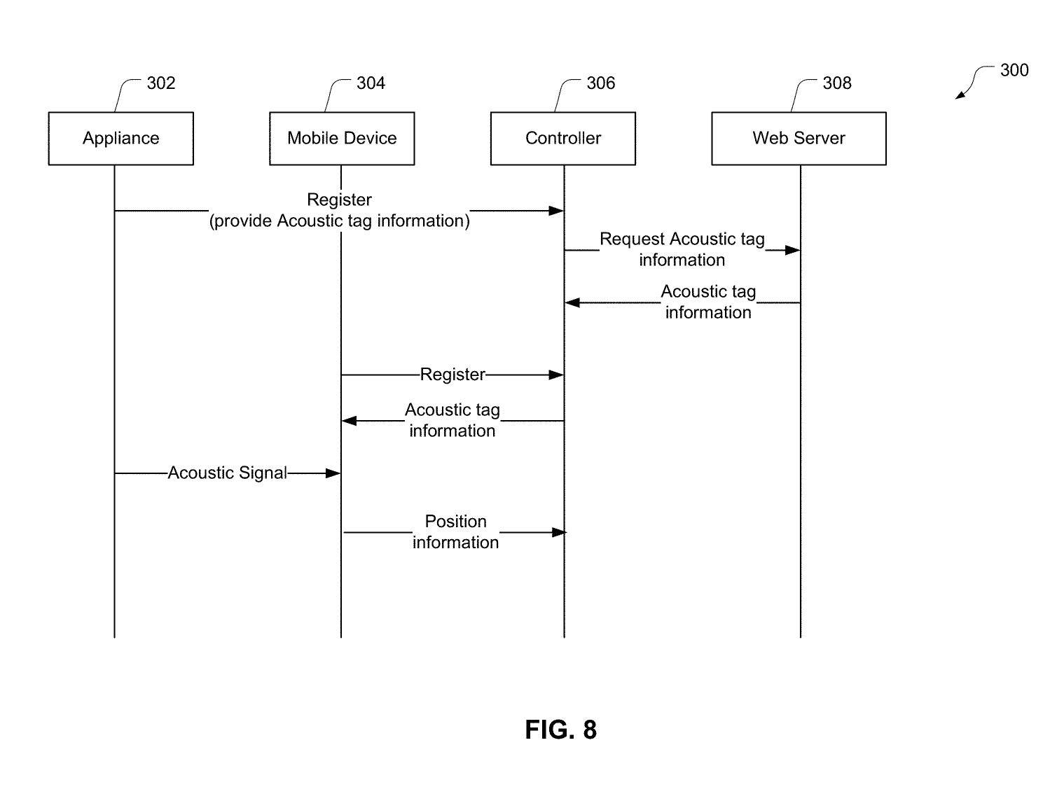

Referring to FIG. 8, an example message flow 300 for determining a position based on an acoustic tag is shown. The message flow 300 is an example of communication between networked devices on a home network and includes an appliance 302, a mobile device 304, a controller 306 and a web server 308. The appliance 302 may be a device 40-43, 46, 47, 102a, 104a, 106a, 110a, 112, 116, 118. The mobile device 304 may be tablet 44, smart phone 45, mobile device 100, tablet 205. The controller 306 may be the central controller 60 or a device 70. The web server 308 may be one or more remote servers containing acoustic tag information and may be accessed via the internet. During device registration, such as when a new appliance is installed or powered-up, the appliance 302 is configured to provide acoustic tag information to the controller 306. In an example, the acoustic tag information may be one or vector models associated with the sounds generated by the appliance 302. The vector models may be developed by the manufacturer of the appliance 302 and stored in memory 82 at the time of manufacture. The appliance 302 may also provide location information to the controller. In an example, the appliance 302 provides device identification to the controller 306 and the controller 306 is configured to retrieve the acoustic tag information from the web server 308 based at least in part on the device identification. The web server 308 may be established by the manufacturer or a third party and is configured to provide acoustic tag information (e.g., vector models) based on appliance identification information. In an example, the controller 306 may be configured to periodically access the web server 308 to update the acoustic tag information. Through such a registration process, the controller 306 may maintain a database of acoustic tags for each device in the home network.

The mobile device 304 may register with the controller 306 when joining the home network. For example, the controller 306 may be part of an 802.11 network and may request authentication information from the mobile device 304. The authentication may include a security exchange such as Wired Equivalent Privacy (WEP) and Wi-Fi Protected Access (WPA), or other security protocols. During the registration process, the controller 306 may be configured to provide acoustic tag information for the devices in the home 200 to the mobile device 304. In an example, the acoustic tag information may be stored in memory 82 on the mobile device 304 and subsequent registration processes may be limited to updating the acoustic tag information to ensure the most current files are being used. In operation, the mobile device 304 may detect an acoustic signal emitted from the appliance 302 and perform the process 250 on captured sound. The resulting vector model may be compared (e.g., correlated) to the acoustic tag information received from the controller 306 to determine the identification and location of the appliance 302. The mobile device 304 may be configured to utilize the acoustic signal to determine a position and provide the position information to the controller 306. In an example, the mobile device 304 may provide the acoustic signal to the controller 306 as an audio file, and the controller 306 may be configured to perform the correlation with the acoustic tag database. The controller 306 may maintain position information for the mobile device 304 and provide the computed position information to the mobile device 304 or to other applications.

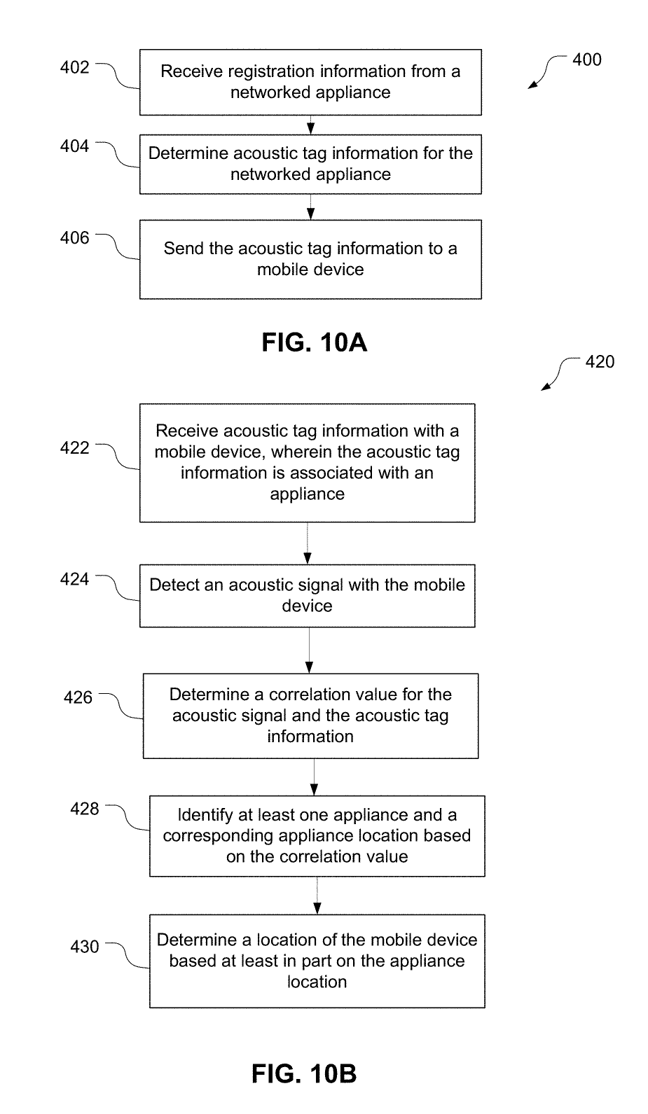

Referring to FIG. 10A, with further reference to FIGS. 1-9C, a method 400 for sending acoustic tag information to a mobile device 100 includes the stages shown. The method 400 is, however, an example only and not limiting. The method 400 can be altered, e.g., by having stages added, removed, rearranged, combined, performed concurrently, and/or having single stages split into multiple stages.

At stage 402, the central controller 60, or other device 70, receives registration information from a network appliance. The networked appliance may be an appliance/device may be one of the devices 40-43, 46, 47, 102a, 104a, 106a, 110a, 112, 116, 118 in a home network. The registration information may include device identification information to uniquely identify the appliance in the home network. The device identification information may include information such a manufacturer, a model number and/or a serial number. The registration information may also include the location of the networked appliance. The location may be entered by a user at time of installation, or it may be computed based on other positioning techniques such as SPS, RTT, OTDOA, RSSI, etc. Other identification information may also be used. The registration information may be received by the central controller 60 when the networked appliance whenever the appliance performs a registration process, such as when initially configured to communicate on the home network, or at other times such as when the appliance is activated.

At stage 404, the central controller 60, or other device 70, determines acoustic tag information for the networked appliance. In an example, the registration information received at stage 402 may include acoustic tag information such as one or more vector models corresponding to the acoustic emissions of the network appliance. The acoustic tag information may be provided during the registration process. In an example, the central controller 60 may be configured to obtain the acoustic tag information from a remote database such as web server. The device identification information may be used to access the remote database to obtain one or more files containing the acoustic tag information (e.g., vector models, file dates, sound levels). The central controller 60 stores the acoustic tag information in one or more tables such as the first acoustic tag attribute table 320 in FIG. 9A.

At stage 406, the central controller 60, or other device 70, sends the acoustic tag information to a mobile device 304. In an example, the central controller 60 utilizes data frames in existing wireless messaging protocols (e.g., 802.11, BT-LE) to send the acoustic tag information. The mobile device 304 may receive the acoustic tag information directly from the other devices 70 (e.g., when the devices are in communication range), or from the central controller 60. In an example, the mobile device 304 may receive the acoustic tag information during a registration process with the central controller 60 when the mobile device 304 joins the home network. In an example, the acoustic tag information can be provided to the mobile device 304 on a periodic basis, when the acoustic tag information is updated, when the state of an appliance changes, or when new appliances are added to the network. The mobile device 304 may be configured to store the received acoustic tag information in a local memory and utilize the acoustic tag information for subsequent positioning processes.

Referring to FIG. 10B, with further reference to FIGS. 1-9C, a method 420 for determining the position of a mobile device includes the stages shown. The method 420 is, however, an example only and not limiting. The method 420 can be altered, e.g., by having stages added, removed, rearranged, combined, performed concurrently, and/or having single stages split into multiple stages.

At stage 422, the mobile device 304 receives acoustic tag information associated with an appliance 302. The mobile device 304 may be part of a home network and configured to communicate with a controller 306. In an example, the controller 306 may utilize data frames in existing wireless messaging protocols (e.g., 802.11, BT-LE) to send the acoustic tag information to the mobile device 304. The acoustic tag information may include one or more fields in the first acoustic tag attribute table 320 such as the index 326, the file date 328, the device ID 330, the acoustic tag information 332, the device location 334, the sound level 336, and the state indicator 338. The device ID 330 uniquely identifies an appliance 302 within the home network and corresponding acoustic tag information 332 may include one or more vector models corresponding to the acoustic output generated by the appliance 302. The acoustic tag information may be stored in the memory of the mobile device and available for positioning applications. In an example, the appliance 302 may provide the acoustic tag information directly to the mobile device 304 through the home network. The mobile device 304 may be configured to access the web server 308 to obtain acoustic tag information based on device ID data (e.g., entered manually by the user, or received via the network from the appliance 302).

In an embodiment, the mobile device 304 may be configured to capture one or more acoustic outputs from the appliance 302 and generate the acoustic tag information. For example, the mobile device 304 may record the acoustic output while the appliance is operating, and then perform the process 250 to generate one or more vector models to be included in the acoustic tag information. The user may manually enter, or receive via a wired or wireless connection, one or more other attributes such as the device ID 330, device location 334 and/or the state indicator 338. The acoustic tag information stored by the mobile device 304 may be provided to the controller 306 or other devices on the home network.

At stage 424, the mobile device 304 detects an acoustic signal. The appliance 302 generates one or more sounds when it is operating. The mobile device 304 may capture the sounds with one or more microphones and perform the process 250 to generate a vector model based on the frequency transformation of the time based acoustic signal. The acoustic signal may not be in the audible frequency range of human ears but may be detected by a high sensitivity microphone in the mobile device 304. The vector model may be generated by the mobile device 304 (e.g., local processing), or an acoustic recording may be provided to the controller 306 to generate the vector model (e.g., remote processing). The generated vector model may be stored as the acoustic sample 352. The mobile device 304 may also determine a peak/amplitude of the captured sound and store that value as the detected level 354. While only one appliance 302 is depicted in FIG. 8, multiple appliances may be operation and the acoustic signal captured by mobile device 304 may include audio components from each of the multiple appliances.

At stage 426, the mobile device 304 or the controller 306 determines a correlation value for the acoustic signal and the acoustic tag information. The vector model generated at stage 424 may be used with a retrieval algorithm to find a matching acoustic tag in the acoustic tag information received at stage 422. At stage 428, the mobile device 304 or the controller 306 identifies at least one appliance and a corresponding appliance location based on the correlation value. For example, correlation algorithms or other match filtering techniques may be used to identify a previously stored acoustic tag with an acoustic tag generated from a currently captured acoustic signal. The mobile device 304 or the controller 306 may determine correlation values between one more acoustic tags 332 and the acoustic sample 352. The acoustic tag 332 with the highest correlation may be selected as a proximate device. If the acoustic signal captured by the mobile device includes components from multiple appliances, the correlation algorithm may provide a list of devices with approximately equal correlation scores. The device locations 334 of each of these devices may be used to determine the location of the mobile device 304.

At stage 430, the mobile device 304 or the controller 306 determines a location of the mobile device 304 based at least in part on the appliance location. For example, the mobile device 304 or the controller 306 may utilize the device location 334 values of the device(s) with the highest correlation results to determine a coarse location of the mobile device 304 (e.g., proximity based location). The detected level 354 may be compared to the sound level 336 to determine the relative strengths of received sounds. Since the locations and acoustic levels of each of the appliances is known (e.g., the device location 334, the sound level 336), the mobile device 304 or the controller 306 may utilize ranged based trilateration or other relative positioning techniques to determine the location of the mobile device 304.

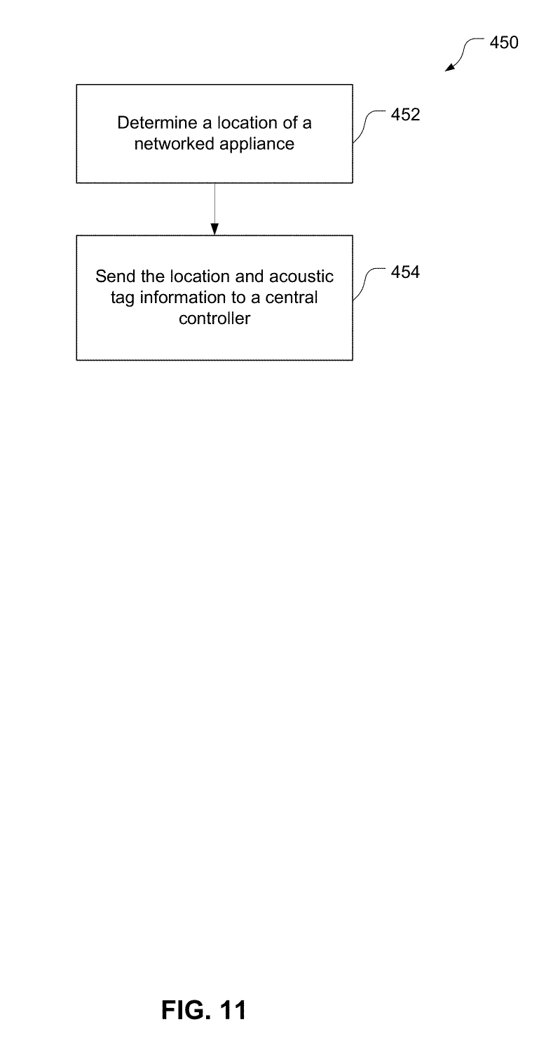

Referring to FIG. 11, with further reference to FIGS. 1-9C, a method 450 of sending acoustic tag information to a central controller includes the stages shown. The method 450 is, however, an example only and not limiting. The method 450 can be altered, e.g., by having stages added, removed, rearranged, combined, performed concurrently, and/or having single stages split into multiple stages.

At stage 452, an appliance 302 or the controller 306 determines the location of a networked appliance. The appliance 302 and the controller 306 are devices on a common network. In an example the appliance 302 is a device 70 and may be configured to determine its location based on computed ranges to other of the devices in the network using RTT, or OTDOA, or RSSI, or one or more other techniques, or a combination of one or more of any of these techniques. In an example, a user may enter the location information associated with the appliance 302 manually. Other applications executing on a mobile device (e.g., smartphone, tablet, etc.) may utilize the navigation system of the mobile device to determine the location of the appliance. For example, the mobile device may connect to the appliance via a wired or wireless connection to exchange location and other operational parameters (e.g., system setting, default parameters, etc.).

At stage 454, the appliance 302 sends the location and acoustic tag information to a controller 306. In an example, the acoustic tag information may be previously stored in the appliance 302 (e.g., memory 82) and the location and acoustic tag information may be provided during a registration process with the controller 306. The appliance 302 may be configured to retrieve the acoustic tag information from a remote server via the internet or other external network. The appliance 302 may utilize data frames in existing wireless messaging protocols (e.g., 802.11, BT-LE) to send the acoustic tag information. The acoustic tag information may include attributes such as a device ID, a file date (e.g., to indicate the time or version of the acoustic tag information), one or more acoustic tags (e.g., vector models), sound decibel levels, and state indicators (e.g., to indicate the state of the appliance corresponding to an acoustic tag). The acoustic tag information may be stored in one or more attribute tables on the controller 306 (e.g., the first attribute table 320) and provided to other devices in the home network.

While the acoustic tag positioning has been described above in references to a home network, the invention is not so limited. The proposed approach may also be useful in public areas such as fairgrounds, amusement parks, shopping malls, and other such places including multiple stalls/locations that are providing individual announcements. Each of the stalls/locations may have specific acoustics tags associated to them which may be updated when a user approaches the area. The approach may also be utilized in other public places such as airports, railway stations and other areas where location specific general announcements are heard. Each announcement may be prefixed with a specific acoustic tag that is associated with a location.

In other examples, the acoustic tags may be used in conjunction with any of the existing approaches of indoor positioning to improve the location accuracy and minimize the associated overheads with the existing approaches. Acoustic tags may also be used and enabled whenever an E911 call is placed and various networked devices may be controlled to transmit their associated sound tag immediately for fast and accurate position determination. For example, the mobile device 304 may be configured to activate its microphone when an emergency 911 call is placed and the controller 306 may instruct one or more appliances 302 in the vicinity of the mobile device 304 to emit an acoustic signal (e.g., corresponding to their respective acoustic tag information).

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, an indication that a device is configured to perform a stated function means that the device contains appropriate equipment (e.g., circuitry, mechanical device(s), hardware, software (e.g., processor-readable instructions), firmware, etc.) to perform the stated function. That is, the device contains equipment that is capable of performing the stated function, e.g., with the device itself having been designed and made to perform the function, or having been manufactured such that the device includes equipment that was designed and made to perform the function. An indication that processor-readable instructions are configured to cause a processor to perform functions means that the processor-readable instructions contain instructions that when executed by a processor (after compiling as appropriate) will result in the functions being performed.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, a wireless communication device may communicate through one or more wired connections as well as through one or more wireless connections.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A method of determining a location of a mobile device, comprising:
receiving acoustic tag information with the mobile device, wherein the acoustic tag information is associated with an appliance;
detecting an acoustic signal with the mobile device;
determining a correlation value for the acoustic signal and the acoustic tag information;
identifying at least one appliance and a corresponding appliance location based on the correlation value; and
determining the location of the mobile device based at least in part on an appliance location.

2. The method of claim 1 wherein the acoustic tag information includes a sound level and the acoustic signal includes a detected level.

3. The method of claim 2 further comprising determining a range between the at least one appliance and the mobile device based on a comparison of the sound level and the detected level.

4. The method of claim 1 wherein the acoustic signal is not in an audible frequency range of human ears.

5. The method of claim 1 wherein the acoustic tag information is received from a central controller on a home network.

6. The method of claim 1 wherein the acoustic tag information is received from the appliance.

7. The method of claim 1 wherein the acoustic tag information includes a vector model.

8. The method of claim 1 further comprising identifying a plurality of appliances and a plurality of corresponding appliance locations based on the correlation value, and determining the location of the mobile device based at least in part on the plurality of corresponding appliance locations.

9. A mobile device for determining a location, comprising:
a transceiver configured to receive acoustic tag information, wherein the acoustic tag information is associated with an appliance;
a microphone configured to detect an acoustic signal;
a processor operably coupled to the transceiver and the microphone, and configured to:
determine a correlation value for the acoustic signal and the acoustic tag information;
identify at least one appliance and a corresponding appliance location based on the correlation value; and
determine the location of the mobile device based at least in part on an appliance location.

10. The mobile device of claim 9 wherein the acoustic tag information includes a sound level and the acoustic signal includes a detected level.

11. The mobile device of claim 10 wherein the processor is further configured to determine the location of the mobile device based at least in part on a comparison of the sound level and the detected level.

12. The mobile device of claim 9 wherein the microphone is configured to detect the acoustic signal that is not in an audible frequency range of human ears.

13. The mobile device of claim 9 wherein the acoustic tag information is received from a central controller on a wireless home network.

14. The mobile device of claim 9 wherein the acoustic tag information is received from the appliance on a wireless home network.

15. The mobile device of claim 9 wherein the acoustic tag information includes a vector model.

16. The mobile device of claim 9 wherein the processor is further configured to activate the microphone to detect one or more acoustic signals when an emergency 911 call is placed.

17. An apparatus for determining a location of a mobile device, comprising:
means for receiving acoustic tag information with the mobile device, wherein the acoustic tag information is associated with an appliance;
means for detecting an acoustic signal with the mobile device;
means for determining a correlation value for the acoustic signal and the acoustic tag information;
means for identifying at least one appliance and a corresponding appliance location based on the correlation value; and
means for determining the location of the mobile device based at least in part on an appliance location.

18. The apparatus of claim 17 wherein the acoustic tag information includes a sound level and the acoustic signal includes a detected level.

19. The apparatus of claim 18 further comprising means for determining a range between the at least one appliance and the mobile device based on a comparison of the sound level and the detected level.

20. The apparatus of claim 17 wherein the acoustic signal is not in an audible frequency range of human ears.

21. The apparatus of claim 17 wherein the acoustic tag information is received from a central controller on a home network.

22. The apparatus of claim 17 wherein the acoustic tag information is received from the appliance.

23. The apparatus of claim 17 wherein the acoustic tag information includes a vector model.

24. The apparatus of claim 17 further comprising to means to activate a microphone to detect one or more acoustic signals when an emergency 911 call is placed.

25. A non-transitory processor-readable storage medium comprising processor-readable instructions configured to cause one or more processors to determine a location of a mobile device, comprising:
code for receiving acoustic tag information with the mobile device, wherein the acoustic tag information is associated with an appliance;
code for detecting an acoustic signal with the mobile device;
code for determining a correlation value for the acoustic signal and the acoustic tag information;
code for identifying at least one appliance and a corresponding appliance location based on the correlation value; and
code for determining the location of the mobile device based at least in part on an appliance location.

26. The storage medium of claim 25 wherein the acoustic tag information includes a sound level and the acoustic signal includes a detected level.

27. The storage medium of claim 26 further comprising code for determining a range between the at least one appliance and the mobile device based on a comparison of the sound level and the detected level.

28. The storage medium of claim 25 wherein the acoustic signal is not in an audible frequency range of human ears.

29. The storage medium of claim 25 wherein the acoustic tag information is received from the appliance.

30. The storage medium of claim 25 further comprising code for activating a microphone to detect one or more acoustic signals when an emergency 911 call is placed.
